(19) United States
(12) Patent Application Publication
(10) Pub. No.: US 2009/0313654 A1
(43) Pub. Date: Dec. 17, 2009

(54) SYSTEM AND METHOD FOR INSERTION OF ADVERTISEMENT INTO PRESENTATION DESCRIPTION LANGUAGE CONTENT

(75) Inventors: Toni Juhani Paila, Koisjarvi (FI); Topi-Oskari Pohjolainen, Helsinki (FI); Esa Pekka Jalonen, Espoo (FI)

Correspondence Address: Nokia, Inc., 6021 Connection Drive, MS 2-5-520, Irving, TX, 75039, US

(73) Assignee: Nokia Corporation, Espoo (FI)

(21) Appl. No.: 12/390,413

(22) Filed: Feb. 21, 2009

Related U.S. Application Data
(60) Provisional application No. 61/030,893, filed on Feb. 22, 2008.

(51) Int. Cl. H04N 7/10

(52) U.S. Cl. 725/32

(57) ABSTRACT

A method includes receiving a content update for content presented using a presentation description language and inserting complementary information in the content based on the content update using the presentation description language. The content presented in the presentation description language may be Rich Media Environment (RME) content, and the complementary information may include one or more advertisements.

### RELATED APPLICATION

This application claims priority to U.S. Application No. 61/030,893 filed Feb. 22, 2008, which is hereby incorporated by reference in its entirety.

### FIELD OF THE INVENTION

The present invention relates generally to content that is presented using a description language, such as Rich Media Environment. More particularly, the present invention relates to insertion of advertisements into a scene or multimedia presentation in such content.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Rapid developments in wireless communications, media broadcasting, and content distribution continue facilitating the delivery of various services and products to mobile devices. One such service, Mobile TV, involves the delivery of various entertainment content and services to mobile users, allowing personalized and interactive viewing of TV content that is specifically adapted for mobile medium. In addition to mobility and enabling the reception of a pure broadcast (i.e., traditional) TV programs, mobile TV may be adapted to deliver a variety of additional services and features such as video-on-demand, personalized content delivery, interactive voting, SMS messaging, live chatting, targeted advertising links, and the like, that represent a merger of wireless communications with the Internet and the traditional TV broadcast services.

The development of the mobile broadcast infrastructure has also spurred the demand for what is called Rich Media Environment, or RME, content. RME is generally referred to content that is graphically rich and contains compound (or multiple) media, including graphics, text, video and audio.

Service and/or content may be formatted as OMA Rich Media Environment (RME)/3GPP Dynamic Interactive Multimedia Scenes (DIMS).

### SUMMARY OF THE INVENTION

In one aspect, a method includes receiving a content update using presentation description language and inserting complementary information to the content to be presented using the presentation description language based on the content update. The content presented using presentation description language may be, in one embodiment, Rich Media Environment (RME) content, and the complementary information may include one or more advertisements.

These and other advantages and features of various embodiments, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

Different embodiments of the invention are described by referring to the attached drawings, in which:

FIG. 1 illustrates an exemplary block diagram of an embodiment;

FIG. 2 illustrates various levels of specialization in accordance with different embodiments;

FIG. 3 schematically illustrates various embodiments;

FIG. 4 illustrates an exemplary process in accordance with different embodiments;

FIG. 5 illustrates an exemplary process 500 for the development of end user preferences or profile in accordance with an embodiment;

FIG. 6 is a perspective view of an electronic device that can be used in conjunction with the implementation of various embodiments;

FIG. 7 a schematic representation of the circuitry which may be included in the electronic device of FIG. 6.

### DETAILED DESCRIPTION OF VARIOUS EMBODIMENTS

In the following description, for purposes of explanation and not limitation, details and descriptions are set forth in order to provide a thorough understanding of the present invention. However, it will be apparent to those skilled in the art that the present invention may be practiced in other embodiments that depart from these details and descriptions.

Advertisements can be fixed by the time of broadcast by directly encoding them into the media stream. However, in order to get better revenue out of ads the ads themselves should be audience specific (targeted ads). Furthermore, the exact timing of an advertisement is not always known beforehand. It may be desirable to have the capability of triggering the rendering of the advertisement without further notice. For example, an advertisement may be desired to be placed just after a goal in football match.

In conventional broadcasts, advertisements are inserted into the broadcast stream so that the broadcast content and advertisements alternate. By using RME descriptions for a scene the broadcast or multicast content comprising audio, video, images, textual information using different fonts may be simultaneously rendered in a terminal.

In accordance with embodiments, one or more advertisements or other additional or complementary information and/or content may be inserted into a scene or multimedia presentation that is defined with a scene or presentation description language, such as Rich Media Environment (RME). RME is defined by Open Mobile Alliance (OMA) in the following documents: Rich Media Environment Technical Specification; Draft Version 1.0-12 Nov. 2007; OMA-TS-RME-V1_{—}0-20071112-D; Rich-Media Environment Requirements; Draft Version 1.0-25 Aug. 2005; OMA-RD-RichMediaEnvironment-V1_{—}0_{—}4-20050825-D; and Rich Media Environment Architecture; Draft Version 1.0-15 Jun. 2007; OMA-AD-Rich_Media_Environment-V1_{—}0-20070615-D. Each of these documents is available for downloading at: http://member.openmobilealliance.org/ftp/Public_documents/BT/MAE/Permanent-documents/.

In addition to RME, other scene or presentation description languages are contemplated within the scope of the present invention. Other such languages include Dynamic and Interactive Multimedia Scenes (DIMS), described in document 3GPP TS 26.142 V7.2.0 (2007-12) Technical Specification Dynamic and Interactive Multimedia Scenes; (Release 7), available for downloading at: http://www.3gpp.org/ftp/Specs/archive/26%5Fseries/26.142/.

Additionally, another such language is Synchronized Multimedia Integration Language (SMIL) 1.0 Specification (W3C Recommendation 15 Jun. 1998) available for downloading at: http://www.w3.org/TR/REC-smil/.

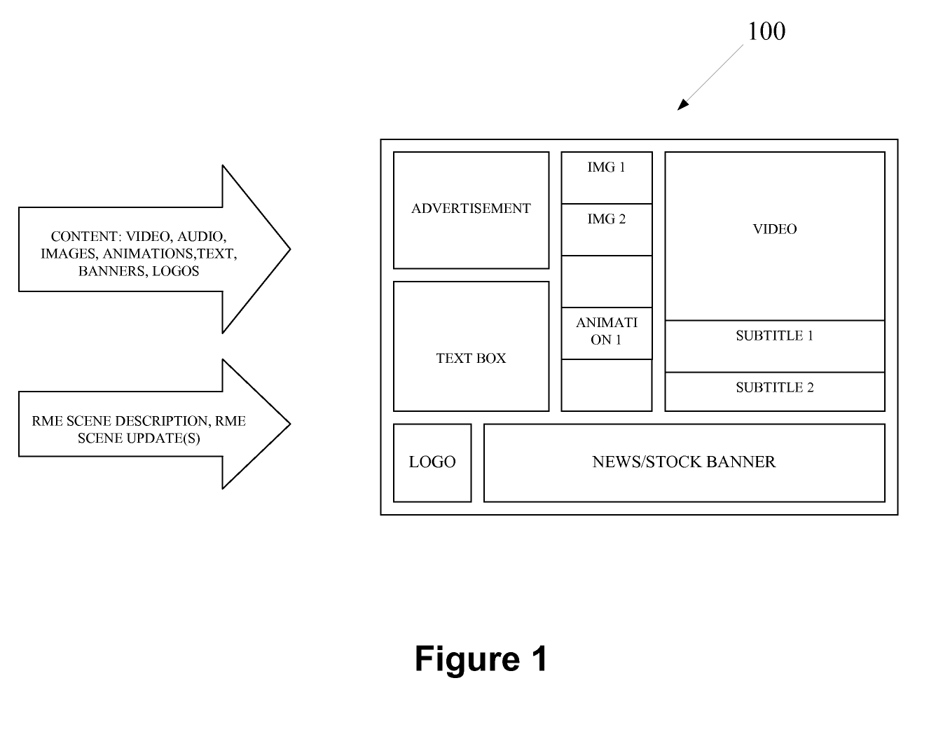

In accordance with embodiments, as exemplarily illustrated in FIG. 1, an advertisement, or other complementary information or content, may be inserted into a scene or a presentation using one or more scene updates. RME-defined content may comprise scenes including one or more visual objects such as video, images, animations and text and audio objects. When using RME, the scene may be updated with new information that may replace those parts of the scene that are changed. A scene or presentation description defines visual and audio objects and the layout of these objects on the presentation screen that is called in RME specification a drawing canvas. The description of the scene or presentation also may define any temporal relations between the objects in the scene, as well as local and remote interaction with scene objects. The scene description language of RME is based on Scalable Vector Graphics (SVG) specification that is published in several versions including SVG Basic and SVG Tiny and which are available for downloading at http://www.w3.org/Graphics/SVG/. Other alternatives are Lightweight Application Scene Representation (LASeR), standardized as ISO/IEC FDIS 14496-20:2006(E): Information technology—Coding of audio-visual objects—Part 20: Lightweight Application Scene Representation (LASeR) and Simple Aggregation Format (SAF), downloadable at: http://www.mpeg-laser.org/documents/DRAFT_LASER_{—}2ND_ED.pdf, Macromedia/Adobe proprietary Flash (downloadable at http://www.adobe.com/products/flash/) and Microsoft proprietary Silverlight (downloadable at http://www.microsoft.com/silverlight/).

In accordance with embodiments, a scene update may change a part of scene, the layout of the scene, temporal relations between the scene objects and/or interaction with the scene objects. The update commands may allow insertion, deletion, replacement and add operations. In one embodiment, the scene update commands may change the layout so that parts of the layout are overlapping with different opacities. Further, the scene description and/or updates may have scripts embedded or included for modifying the scene or its update and/or modifying any scene objects and their mutual relations. The scripts may be based to ECMAScript Language specification, available for downloading at: http://www.ecma-international.org/publications/standards/Ecma-262.htm, but other scripts may also be used and are contemplated within the scope of the present invention.

In addition to advertisement insertion, the complementary and/or additional information may include the presentation of a selection box or a pull-down menu for selecting an item. Further, the complementary information may include notifications such as changes in program schedules, weather, traffic warnings, or other such notification.

Thus, in accordance with embodiments, the network may issue an RME scene update by which an advertisement may be inserted into an RME descripted scene. The advertisement may be delivered to the user terminal in a variety of manners. In one embodiment, the content of the advertisement is included in the update itself. In another embodiment, the content of the advertisement is pre-provisioned and referenced by the update. The user terminal may then retrieve the pre-provisioned content based on the reference. In yet another embodiment, the content of the advertisement is retrieved by the user terminal interactively upon receipt of the update. In still another embodiment, the content of the advertisement may be received from a broadcast delivery session.

In one embodiment, the RME scene update can be generated indirectly by the terminal itself through the use of, for example, proprietary signaling from the network. This may be useful when the network has a legacy advertisement trigger signaling as the legacy signaling is converted to an RME scene update.

In one embodiment, the content of the advertisement may be either terminal-specific or end-user-specific. In this regard, the advertisement can be targeted for consumption by a particular terminal or end user.

In one embodiment, a single RME stream delivers the same scene updates to all terminals. The scene update handling may be specific to terminal type and/or end user. In another embodiment, different RME streams deliver scene updates to specific terminal types and/or end users. In still another embodiment, a combination of the two above may be used. In this regard, the granularity of specialization may be varied. For example, multiple RME streams may be implemented with each RME stream being specific to a certain group of end users or terminal types.

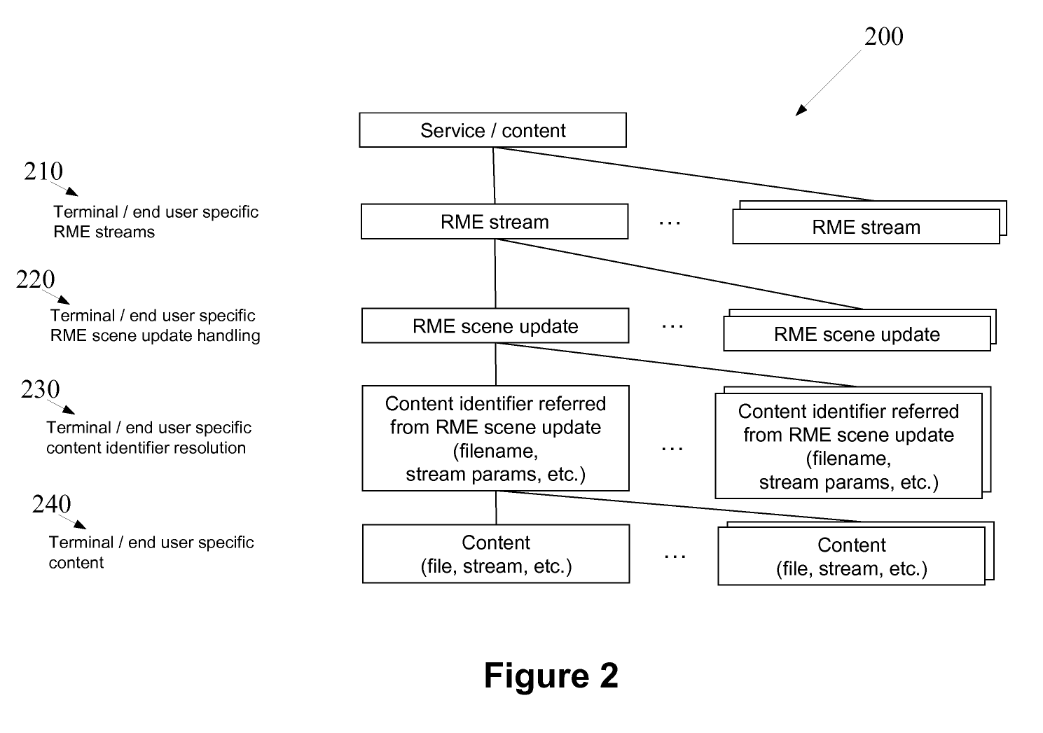

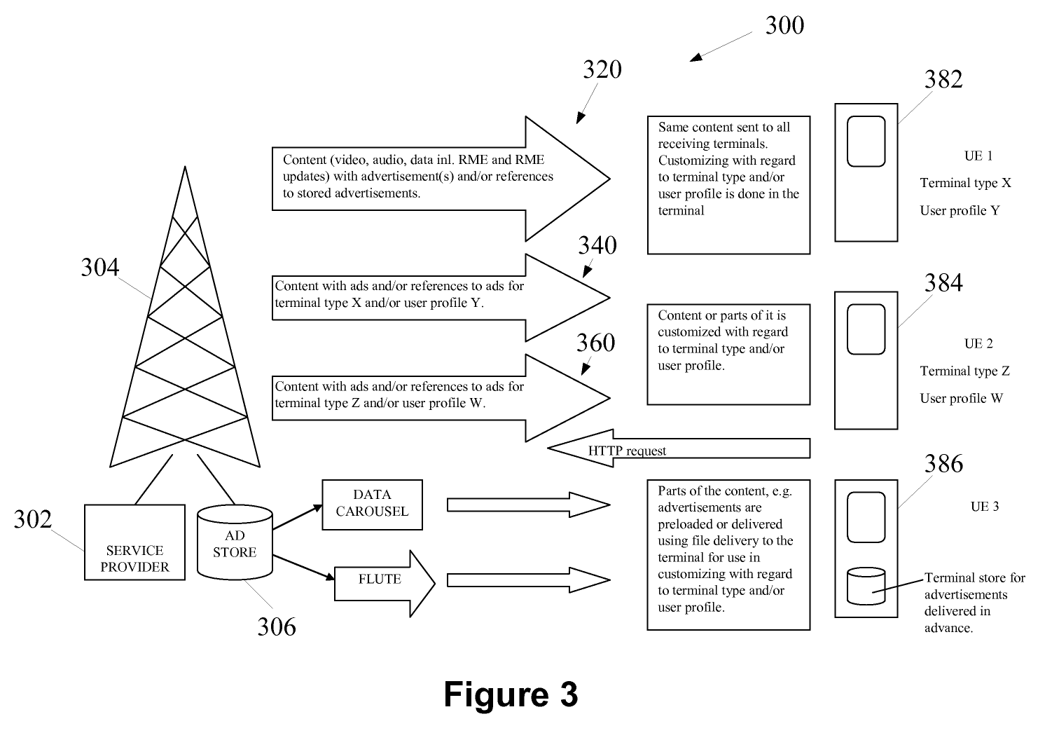

Referring now to FIGS. 2 and 3, the various levels of specialization are illustrated. In one embodiment, terminal or end-user specific RME streams are implemented 210. In this regard, before starting to consume a service and/or content, access to an RME stream is selected based on the terminal type or end user preferences. For example, Open Mobile association Digital Mobile Broadcast (OMA BCAST) Service Guide can be used to associate a particular RME stream access with a terminal type and/or end user preferences. In one embodiment, this may be achieved by instantiating multiple “Access” fragments, each with a particular “TargetUserProfile” element.

In another embodiment, terminal or end-user specific RME scene update handling is implemented 220. In this regard, upon receipt of an RME scene update, the terminal processes the update based on the terminal type and/or end user preferences. One way to achieve this is by embedding a script in the scene update where the script can determine the terminal type and/or end user preferences. The specific processing of the scene update may be performed by the script itself, or the script could modify the XML Document Object Model (DOM), resulting indirectly in a terminal type and/or end user specific update. In another embodiment, the script may reside in the root RME document. In another embodiment, the terminal type and end user specific handling can be performed by a terminal type and/or end user specific part of the RME user agent itself.

In another embodiment, terminal or end-user specific content identifier resolution is implemented 230. This may be considered a special case of the RME scene update handling 220 described above. In this regard, the core of the RME scene update is performed independently of the terminal type and end user preferences. Only the content references are resolved in terminal type and/or end user preference specific manner. In another implementation, the core of the RME scene update is performed independently of the terminal type and end user preferences, and only the content references are resolved based on the terminal type and/or end user preferences.

In another embodiment, terminal or end-user specific content is implemented 240. In this regard, up to this point both the RME scene update itself and its handling may have been processed identically or resulting in identical content reference. At this point, even though the content references are identical, the content referenced differs with respect to terminal type and/or end user preferences. The may be realized using terminal type and/or end user preference specific content delivery.

Referring now to FIG. 3, in accordance with embodiments, the advertisements or other information or content may be inserted to predefined triggering points, for example legacy advertisement insertion points, event-triggered instances of time that are dependent on the main content, e.g., when a goal is made in a soccer or ice hockey game or when the game is interrupted, or trigger point(s) generated by user action, e.g., pointing and/or selecting an item on the screen.

Thus, as exemplarily illustrated in FIG. 3, a communication system 300 may include a service provider 302 having one or more base stations 304 forming a network for transmission and reception of communication signals. Various advertisements may be stored by the service provider 302 in an advertisement storage 306, which may be a database in one embodiment. RME content, or other content presented in a presentation description language, may be delivered to one or more user terminals. In the embodiment illustrated in FIG. 3, three user terminals 382, 384, 386 are illustrated. Those skilled in the art will understand that a much larger number of users may be accommodated by such communication systems 300. Each user terminal may be associated with a terminal type and/or a user profile. In the illustrated embodiment, a first user terminal 382 has a terminal type “X” and a user profile “Y”, while a second user terminal 384 has a terminal type “Z” and a user profile “W”.

As described above, various embodiments may deliver content updates in different manners. In one embodiment, as indicated by reference numeral 320 in FIG. 3, a single RME stream delivers the same scene updates to all terminals, regardless of the terminal type or the user profile. In another embodiment, as indicated by reference numerals 340 and 360 in FIG. 3, different RME streams deliver scene updates to specific terminal types and/or end users. In the embodiment of FIG. 3, one RME stream 340 delivers content updates to user terminals having a terminal type “X” and/or a user profile “Y”, which corresponds to the first user terminal 382. Similarly, another RME stream 360 delivers content updates to user terminals having a terminal type “Z” and/or a user profile “W”, which corresponds to the second user terminal 384. As described above, a combination of the two above may be used in other embodiments. In another embodiment, parts of the content, such as advertisements, are preloaded or delivered to one or more user terminals. The preloaded or delivered content may be used in customizing the complementary information, such as advertisements, based on the terminal type and/or the user profile, as is the case for the third user terminal 386 of FIG. 3.

The selection of the advertisement from available advertisements that may be preloaded, delivered in file delivery, or requested by a HTTP request may be dependent on the user profile and/or preferences according to a script in the RME stream. The script defines the items from the user profile database that are taken into account when selecting the advertisement to be played. In such case the user profile is not predefined. In addition to the items in the user profile database the script may use also any other data that is accessible in the terminal such as for example time, date, last contacts, last web search keywords, use statistics, detected neighboring devices etc., thus making the user profile dynamic being for example context and/or location dependent. The scripts may be sent in the root RME data or in the RME updates. The RME update may trigger the HTTP request. The request may also be triggered by the predefined instance of time, by a user action or by a detected event. Further the script may instruct to replace an advertisement in the received content stream wherein the replacing advertisement is selected according to criteria defined above.

One class of events is an user interface (UI) event that is analyzed by an event handler creating a request for scene update to a server. These events include in some embodiments operating a pointing device as a cursor, one or more keypresses, joystick operations, ‘mouse over’ etc. Another class of events may include changes in the rendered video and/or audio stream such as program start or end. The video and/or audio content may be analyzed for exceptions such as a goal or pause in a sports program. Such events may trigger the RME scene update either on the server side or on the terminal side, wherein the inserted advertisement or other complementary information may be included in the update, may be downloaded in advance, retrieved interactively or received in the broadcast session.

In this regard, SVG, RME, Flash, MPEG4-LASeR, or similar technologies (jointly called “RME” in the disclosure) provide ways to describe scenes, layouts and manage updates to those.

In one embodiment, RME scenes, event handlers and DOM processing may be used. A script is associated with the element within RME document. An event handler is associated with the said script. When, for example, a “click” event is identified, it is associated with the event handler that in turn uses, for example, Javascript script or Java code to analyze the event. The event details, together with the commands associated with the event, are sent to the server. The server analyzes the request by the terminal and, based on the information, determines a scene update. The scene update is returned to terminal as a part of response to the request. The scene update is applied towards a master RME document at the terminal and, consequently, the uDOM is manipulated, and the effect of the scene update is shown.

The following piece of RME/SVG describes an exemplary implementation:

```
<?xml version=“1.0” encoding=“UTF-8”?>
<svg xmlns=“http://www.w3.org/2000/svg” version=“1.2”
      xmlns:xlink=“http://www.w3.org/1999/xlink”
      width=“480” height=“272” viewBox=“0 0 480 272”>
  <desc>Example SVG</desc>
  <script type=“application/ecmascript”><![CDATA[
    var urlCallBackObject;
    var targetPostHost = “www.interactionserver.nokia.com”;
    var outside = 999;
    var menu_btn_x = new Array(6);
    var menu_btn_y = new Array(6);
    var menu_btn_action = new Array(6);
    var yspacing = 37;
    menu_btn_x[0] = 30;
    menu_btn_y[0] = 10;
    menu_btn_x[1] = 30;
    menu_btn_y[1] = 10+yspacing;
    menu_btn_x[2] = 30;
    menu_btn_y[2] = 10+yspacing*2;
    menu_btn_x[3] = 30;
    menu_btn_y[3] = 10+yspacing*3;
    menu_btn_x[4] = 30;
    menu_btn_y[4] = 10+yspacing*4;
    PostUrlCallBackClass.prototype = new Object( );
    function PostUrlCallBackClass( ) { }
    PostUrlCallBackClass.prototype.operationComplete = function(AsyncURLStatus status) {
        if(status.success) {
          if(status.contentType == “document/svg+xml”) {
            Node n = parseXML(status.content);
            document.documentElement.importNode(n, true);
            }
          }
      }
    function change_video(evt) {
      var topGroup = document.getElementById(“scene-1”);
      var toBeRemoved = document.getElementById(“next-prog”);
      topGroup.removeChild(toBeRemoved);
      var video = document.getElementById(“v1”);
      video.setAttributeNS(“http://www.w3.org/1999/xlink”, “href”, “fs-s2e4-restaurant.mp4”);
    }
    function show_ack_msg(evt) {
      var svgNS = “http://www.w3.org/2000/svg”;
      var xlinkNS = “http://www.w3.org/1999/xlink”;
      var xmlNS = “http://www.w3.org/XML/1998/namespace”;
      var topGroup = document.getElementById(“top”);
      var toBeAdded = document.createElementNS(svgNS, “image”);
      toBeAdded.setAttributeNS(xlinkNS, “href”, “done.png”);
      toBeAdded.setAttribute(“x”, “130”);
      toBeAdded.setAttribute(“y”, “100”);
      toBeAdded.setAttribute(“width”, “165”);
      toBeAdded.setAttribute(“height”, “78”);
      toBeAdded.setAttribute(“opacity”, “0.7”);
      var anim = document.createElementNS(svgNS, “animate”);
      anim.setAttributeNS(xmlNS, “id”, “id123456”);
      anim.setAttribute(“attributeType”, “CSS”);
      anim.setAttribute(“attributeName”, “opacity”);
      anim.setAttribute(“from”, “0.7”);
      anim.setAttribute(“to”, “0”);
      anim.setAttribute(“dur”, “2s”);
      anim.setAttribute(“begin”, “indefinite”);
      anim.setAttribute(“fill”, “freeze”);
      var discrd = document.createElementNS(svgNS, “discard”);
      discrd.setAttribute(“begin”, “id123456.end”);
      toBeAdded.appendChild(anim);
      toBeAdded.appendChild(discrd);
      topGroup.appendChild(toBeAdded);
      anim.beginElementAt(1);
      var triggerAnim = document.getElementById(“triggered-ad-anim”);
      triggerAnim.beginElementAt(2);
    }
    function show_menu(x, y, target, timestamp, video_name) {
      var button1 = document.getElementById(“button-1”);
      var button2 = document.getElementById(“button-2”);
      var button3 = document.getElementById(“button-3”);
      var button4 = document.getElementById(“button-4”);
      var button5 = document.getElementById(“button-5”);
      button1.setAttribute(“x”, menu_btn_x[0]);
      button1.setAttribute(“y”, menu_btn_y[0]);
      button1.setAttribute(“opacity”, 0.7);
      menu_btn_action[0] =
          “someaction1?”+ “x=” + x + “?” + “y=” + y + “?” +
          “video=” + video_name + “?” + “timestame=” + timestamp;
      button2.setAttribute(“x”, menu_btn_x[1]);
      button2.setAttribute(“y”, menu_btn_y[1]);
      button2.setAttribute(“opacity”, 0.7);
      menu_btn_action[0] =
          “someaction2?”+ “x=” + x + “?” + “y=” + y + “?” +
          “video=” + video_name + “?” + “timestamp=” + timestamp;
      button3.setAttribute(“x”, menu_btn_x[2]);
      button3.setAttribute(“y”, menu_btn_y[2]);
      button3.setAttribute(“opacity”, 0.7);
      menu_btn_action[0] =
          “someaction3?”+ “x=” + x + “?” + “y=” + y + “?” +
          “video=” + video_name + “?” + “timestamp=” + timestamp;
      button4.setAttribute(“x”, menu_btn_x[3]);
      button4.setAttribute(“y”, menu_btn_y[3]);
      button4.setAttribute(“opacity”, 0.7);
      menu_btn_action[0] =
          “someaction4?”+ “x=” + x + “?” + “y=” + y + “?” +
          “video=” + video_name + “?” + “timestamp=” + timestamp;
      button5.setAttribute(“x”, menu_btn_x[4]);
      button5.setAttribute(“y”, menu_btn_y[4]);
      button5.setAttribute(“opacity”, 0.7);
      menu_btn_action[0] =
          “someaction5?”+ “x=” + x + “?” + “y=” + y + “?” +
          “video=” + video_name + “?” + “timestamp=” + timestamp;
    }
    function menu_click(evt) {
      if (evt.target == document.getElementById(“button-1”) ) {
        hide_menu(evt);
        postURL(targetPostHost, menu_btn_action[0], urlCallBackObject, “text”, “ascii”);
      }
      if (evt.target == document.getElementById(“button-2”) ) {
        hide_menu(evt);
        postURL(targetPostHost, menu_btn_action[1], urlCallBackObject, “text”, “ascii”);
      }
      if (evt.target == document.getElementById(“button-3”) ) {
        hide_menu(evt);
        postURL(targetPostHost, menu_btn_action[2], urlCallBackObject, “text”, “ascii”);
      }
      if (evt.target == document.getElementById(“button-4”) ) {
        hide_menu(evt);
        postURL(targetPostHost, menu_btn_action[3], urlCallBackObject, “text”, “ascii”);
      }
      if (evt.target == document.getElementById(“button-5”) ) {
        hide_menu(evt);
        postURL(targetPostHost, menu_btn_action[4], urlCallBackObject, “text”, “ascii”);
      }
    }
    function hide_menu(evt) {
      var button1 = document.getElementById(“button-1”);
      var button2 = document.getElementById(“button-2”);
      var button3 = document.getElementById(“button-3”);
      var button4 = document.getElementById(“button-4”);
      var button5 = document.getElementById(“button-5”);
      button1.setAttribute(“x”, outside);
      button1.setAttribute(“y”, outside);
      button2.setAttribute(“x”, outside);
      button2.setAttribute(“y”, outside);
      button3.setAttribute(“x”, outside);
      button3.setAttribute(“y”, outside);
      button4.setAttribute(“x”, outside);
      button4.setAttribute(“y”, outside);
      button5.setAttribute(“x”, outside);
      button5.setAttribute(“y”, outside);
    }
    function first_click_on_video(evt) {
      var x = evt.screenX; // Get x coordinate for the click
      var y = evt.screenY; // Get y coordinate for the click
      var target = evt.target; // This resolves the target of click,
                    // for example whole video area or defined
                    // part of that (that would be separate element)
      var video_playing = document.getElementById(“video”);
      var timestamp = video_playing.getVideoStreamTime( );
          // The above captures the time of click in terms of current video time
          // This is new extension to DOM access for “video” element
      var video_name = video_playing.getAttributeNS(“http://www.w3.org/1999/xlink”, “href”);
      if (target == document.getElementById(“video”)) {
            // Here we pass resolved event attributes & context to menu creation function
                show_menu(x, y, target, timestamp, video_name);
      }
      if (target == document.getElementById(“hot-area”)) {
            // here goes code if user clicks a specific “hot area” on screen
      }
    }
    function init( ) {
        urlCallBackObject = new PostUrlCallBackClass( );
    }
  ]]></script>
<handler type=“application/ecmascript” ev:event=“load”>
        init( );
  </handler>
  <g id=“top”>
    <g id=“scene-1”>
      <g id=“video”>
              <video id=“v1” begin=“0s” dur=“240s” xlink:href=“carshow_ATSC-MH-
480×272.mp4” x=“0%” y=“0%” width=“480” height=“272”
                    transformBehavior=“geometrical” viewport-fill=“black”>
                <handler type=“application/ecmascript”
ev:event=“click”>first_click_on_video(evt);</handler>
              </video>
              <rect x=“1” y=“1” width=“480” height=“272” fill=“none” stroke=“#777” stroke-
width=“1”/>
      </g>
      <g id=“menu”>
              <image id=“button-1” x=“999” y=“999” width=“124” height=“37” opacity=“0.7”
xlink:href=“btn-watchnow.png”>
                <handler type=“application/ecmascript”
ev:event=“click”>menu_click(evt);</handler>
              </image>
              <image id=“button-2” x=“999” y=“999” width=“124” height=“37” opacity=“0.7”
xlink:href=“btn-record.png”>
                <handler type=“application/ecmascript”
ev:event=“click”>menu_click(evt);</handler>
              </image>
              <image id=“button-3” x=“999” y=“999” width=“124” height=“37” opacity=“0.7”
xlink:href=“btn-bookmark.png”>
                <handler type=“application/ecmascript”
ev:event=“click”>menu_click(evt);</handler>
              </image>
              <image id=“button-4” x=“999” y=“999” width=“124” height=“37” opacity=“0.7”
xlink:href=“btn-share.png”>
                <handler type=“application/ecmascript”
ev:event=“click”>menu_click(evt);</handler>
              </image>
              <image id=“button-5” x=“999” y=“999” width=“124” height=“37” opacity=“0.7”
xlink:href=“btn-back.png”>
                <handler type=“application/ecmascript”
ev:event=“click”>menu_click(evt);</handler>
              </image>
      </g>
      <g id=“bmw-ad”>
              <image x=“250” y=“130” width=“230” height=“132” opacity=“0” xlink:href=“bmw-
ad-text.png”>
                <animate id=“triggered-ad-anim” attributeType=“CSS” attributeName=“opacity”
                        begin=“indefinite” from=“0” to=“0.8” dur=“1s” fill=“freeze”/>
                <animate attributeType=“CSS” attributeName=“opacity”
                        begin=“triggered-ad-anim.begin+3s” from=“0.8” to=“0” dur=“2s”
fill=“freeze”/>
              </image>
      </g>
      <g id=“next-prog”>
              <image x=“0” y=“272” width=“200” height=“63” opacity=“0.8” xlink:href=“coming-
up-title.png”>
                <animate attributeType=“CSS” attributeName=“y”
                        begin=“25” from=“272” to=“209” dur=“2s” fill=“freeze”/>
                <animate attributeType=“CSS” attributeName=“y”
                        begin=“33” from=“209” to=“272” dur=“2s” fill=“freeze”/>
              </image>
              <image x=“200” y=“209” width=“100” height=“31” opacity=“0” xlink:href=“btn-
watchnow.png”>
                <set attributeName=“opacity” to=“0.8” begin=“27s” dur=“6s” fill=“freeze” />
                <animate attributeType=“CSS” attributeName=“y”
                        begin=“33” from=“209” to=“272” dur=“2s” fill=“freeze”/>
                <handler type=“application/ecmascript”
ev:event=“click”>change_video(evt);</handler>
              </image>
              <image x=“200” y=“240” width=“100” height=“35” opacity=“0” xlink:href=“btn-
record.png”>
                <set attributeName=“opacity” to=“0.8” begin=“27s” dur=“6s” fill=“freeze” />
                <animate attributeType=“CSS” attributeName=“y”
                        begin=“33” from=“240” to=“303” dur=“2s” fill=“freeze”/>
                <handler type=“application/ecmascript”
ev:event=“click”>show_ack_msg(evt);</handler>
              </image>
      </g>
    </g>
  </g>
</svg>
```

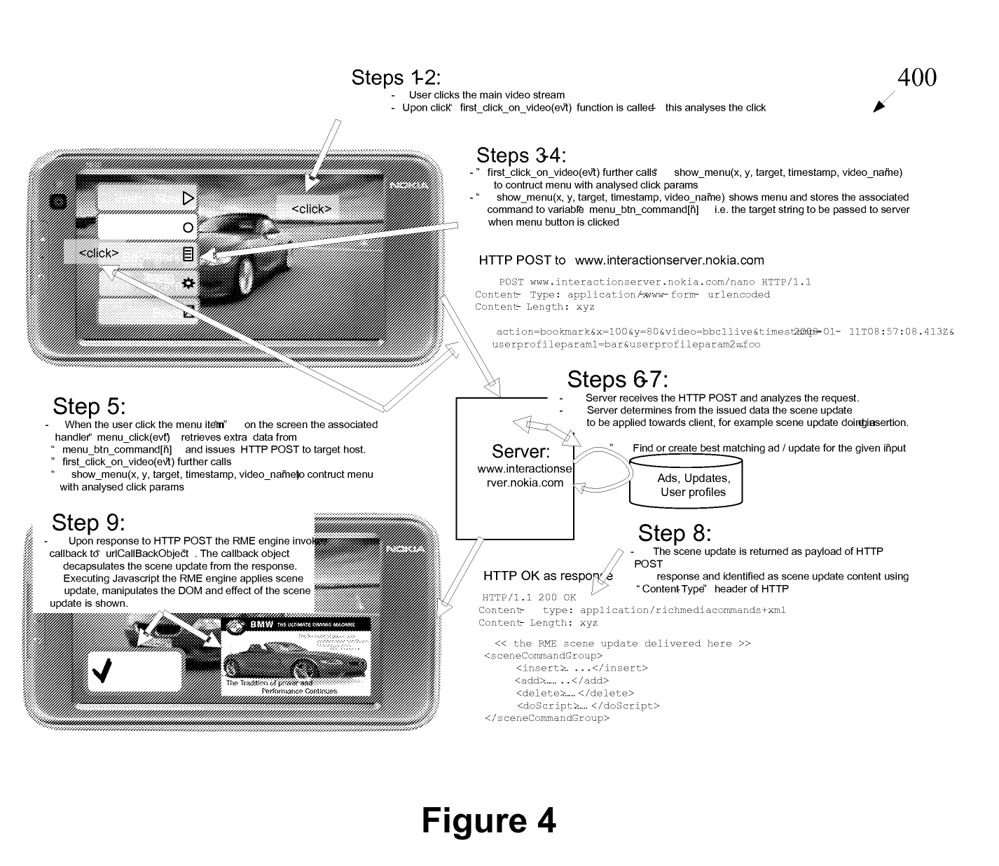

Referring now to FIG. 4, an exemplary process in accordance with different embodiments is illustrated. At step 1, a user clicks the main video stream. Upon click, a “first-click-on-video(evt)” function is called for analyzing the click at step 2. At step 3, the “first-click-on-video(evt)” further calls “show_menu(x, y, target, timestamp, video_name)” to construct menu with analyzed click parameters. The “show_menu(x, y, target, timestamp, video_name)” shows a menu and stores the associated command to variable “menu_btn_command[n]” e.g., the target string to be passed to server when menu button is clicked at step 4. When the user clicks the menu item “n” on the screen, the associated handler “menu_click(evt)” retrieves extra data from “menu_btn_command[n]” and issues HTTP POST to the target host at step 5. Step 1-5 may be achieved with the exemplary script above.

The following describes the processes at the server end. At step 6, the server receives the HTTP POST and analyzes the request. The server determines from the issued data the scene update to be applied towards client for example, scene update doing advertisement insertion at step 7. At step 8, the scene update is returned as payload of HTTP POST response and identified as scene update content using “Content-Type” header of HTTP. The terminal then receives the response from server.

At step 9, upon response to HTTP POST, the RME engine invokes callback to “urlCallBackObject”. The callback object decapsulates the scene update from the response. Executing Javascript, the RME engine applies scene update and manipulates the DOM, and the effect of the scene update is shown.

In some cases, a sender of an RME stream may want to apply a scene update that places a personalize targeted advertisement. The advertisement can be a simple image or even a complete RME document containing richer functionality. The advertisement placement command, or scene update, may need to refer to some resource, for example image or RME document, etc., to be rendered. The sender may only want to send a single scene update. In accordance with embodiments, SVG, RME, Flash, MPEG4-LASeR, or similar scene/layout descriptions and their updates may refer to resources based on criteria instead of being exactly identified.

In this regard, embodiments may 1) use a URI scheme that is specific for criteria based resource access; 2) extend underlying Document Object Model (DOM); or 3) use a local terminal-bound server at “localhost”.

In one embodiment, a URI scheme that is specific for criteria based resource access is used. One exemplary URI scheme is provided below:

Criteria-URI:==URI-scheme-id “://”*(criterion-key “=” criterion-value “?”)
URI-scheme-id:==“cref”
Criterion-key:==<any char string without white spaces>
Criterion-value:==<any char string without white spaces>

The “cref”-scheme can be used wherever URI is used, typically with “xlink:href” or “href” attribute, but not excluded to those only.

Example URI

cref.//ziplocation=10804?genre=sport

The following example illustrates the use of the URI in RME:

```
<g id=“targeted-ad”>
    <image x=“250” y=“130” width=“230” height=“132” opacity=“0.7”
    xlink:href=“cref://ziplocation=10804?genre=sport”/>
</g>
```

In the above example, the RME engine passes the “cref”-URI to corresponding handler. Thus, to support the new “cref”-scheme the RME engine/terminal should have such handler. The handler resolves the passed “cref”-URI to a reference that can be pointed with “href” and passes it back to RME engine. Resolving key-value criteria pairs is specific to each implementation. One way to do this is to keep a registry of keys with each key having multiple possible values that may be in some embodiments prioritized. Further, each key is linked with local resource, for example file. Upon matching the “cref” criteria, each “cref”-key is looked up from the registry and then the looked up values are matched with the value in the “cref”. Finally, the local resource that this way got most matches is returned.

Considering the above example, these two final interpretations are possible after “cref” processing:

1) Resolved to simple image

```
<g id=“targeted-ad”>
    <image x=“250” y=“130” width=“230” height=“132” opacity=“0.7”
    xlink:href=“car-ad.png”/>
</g>
```

2) Resolved more complex way of constructing image

```
<g id=“targeted-ad”>
    <image x=“250” y=“130” width=“230” height=“132” opacity=“0.7”
    xlink:href=“ad-example.svg”/>
</g>
```

The selection of the appropriate, in some embodiments possibly location and end user specific, advertisement clip can be performed, for example, by the following.

The component resolves the URI designating the file. The URI could point directly to the file (file://foo/eric.mpg) or be formed by encoding the criteria to be matched. The latter could be in the form of key-value pairs found in regular URIs. For example, cref://favouriteColour=red&sex=female&age=25 would resolve to a file that represents advertisement for a twenty-five-year-old girl and whose favorite color is red.

The SVG player may provide a static function for scripts to call. This function is provided as part of the global services of the DOM-tree of the viewed document. The criteria, for example the favorite color, sex and age, are given as arguments or parameters of this function by the calling script. In other words, the script is asking for the “viewed document” to resolve the most appropriate file matching the given criteria.

The designation by the network of the file to be rendered as an advertisement will now be addressed. Giving the plain name is trivial and already supported. Here, one enables conditional selection based on the end user preferences or in some embodiments the current location. The trigger from the network for the terminal to render an advertisement could then contain just the criteria encoded URI (“cref”) or piece of script that calls the resolver function provided by the SVG player. The handler for the criteria-encoded URI (“cref”) may be the file system or that part of the SVG player that requests the file system to open the file upon the document or its update telling the player to do so.

In another embodiment, the underlying Document Object Model (DOM) may be extended. The following example is provided with SVG 1.2 Tiny Micro DOM. The SVG uDOM global is extended as follows, wherein the added part is shown with underlining:

```
interface SVGGlobal : Global, EventListenerInitializer2
{
        Connection createConnection( );
        Timer createTimer(in long initialInterval, in long repeatInterval)
            raises(GlobalException);
        void gotoLocation(in DOMString newIRI);
        readonly attribute Document document;
        readonly attribute Global parent;
        DOMString binaryToString(in sequence<octet> octets, in
            DOMString encoding) raises(GlobalException);
        sequence<octet> stringToBinary(in DOMString data, in
            DOMString encoding) raises(GlobalException);
        void getURL(in DOMString iri, in AsyncStatusCallback
        callback);
        void postURL(in DOMString iri, in DOMString data, in
              AsyncStatusCallback callback, in DOMString type,
              in DOMString encoding);
        Node parseXML(in DOMString data, in Document contextDoc);
    DOMString createLocalRefByFilterRules(in DOMString filterRules);
};
```

createLocalRefByFilterRules
Creates a IRI reference associated with local resource (such as file on local file system) that matches with ‘filterRule.

### Parameters:

in DOMString filterRules
“?”-delimited string or key-value pairs where each key precedes its associated value and key is separated from value by a equal sign. Example: “favoriteContent=sailing?userType=male”. Specifies the list of target filter rules based on which the terminal creates a local IRI reference to best-matching resource.
Return value:

DOMString

String representation of the local IRI reference.

### Exceptions

GlobalException

UNDEFINED ERR: Raised if the values for the parameter ‘filterRules’ is not given.

### Example in Use:

```
<script type=″application/ecmascript″> <![CDATA[
  function show_targetted_ad (evt) {
    var svgNS = ″http://www.w3.org/2000/svg″;
    var xlinkNS = ″http://www.w3.org/1999/xlink″;
    var xmlNS = ″http://www.w3.org/XML/1998/namespace″;
    var topGroup = document.getElementById(″top″);
    var toBeAdded = document.createElementNS(svgNS, ″image″);
    var ref = createLocalRefByFilterRules(“ziplocation=
    10804?genre=sport”);
    toBeAdded.setAttributeNS(xlinkNS, ″href″, ref);
    toBeAdded.setAttribute(″x″, ″130″);
    toBeAdded.setAttribute(″y″, ″100″);
    toBeAdded.setAttribute(″width″, ″165″);
    toBeAdded.setAttribute(″height″, ″78″);
    toBeAdded.setAttribute(″opacity″, ″0.7″);
    topGroup.appendChild(toBeAdded);
  } ]]> </script>
```

In another embodiment, a local terminal-bound server is used at the “localhost”. This option is similar to first option. The difference is that in this case, no new URI scheme is required, but the http-URI is used to point to ‘localhost’. The URI definition is as follows:

URI-to-be-used:==“http://localhost/cref?”*(criterion-key “=” criterion-value “?”)
Criterion-key:==<any char string without white spaces>
Criterion-value:==<any char string without white spaces>

Thus “cref” in this case is already existing resource directly at ‘localhost’—for example a server script. This script is passed criterion key-value pairs through normal http methods.

### Example

```
<g id=“targeted-ad”>
    <image x=“250” y=“130” width=“230” height=“132” opacity=“0.7”
    xlink:href=“http://localhost/cref?ziplocation=10804?genre=sport”/>
</g>
```

As described above, user preferences may be used to provide targeted advertisements. In this regard, various embodiments are provided for the creation of end-user preferences and/or profiles. Such user preferences/profiles may take into account the registered user of the terminal including time used and when used, for example the time of the day and/or the day of the week.

End user preferences or profiles may be characterized in numerous ways. Therefore, predefining a general structure for the profile is impractical, if not impossible. In other words, it is very difficult to come up with a preference or profile structure that can accommodate all use cases. Often, lists of “key”-“value” pairs have been utilized, where the “key” represents the parameter in question and the “value” represents the individual value of the parameter. This in turn means that the one providing content or services has no tools for providing arbitrary characteristics that the receiving device can be expected to match with end user preferences.

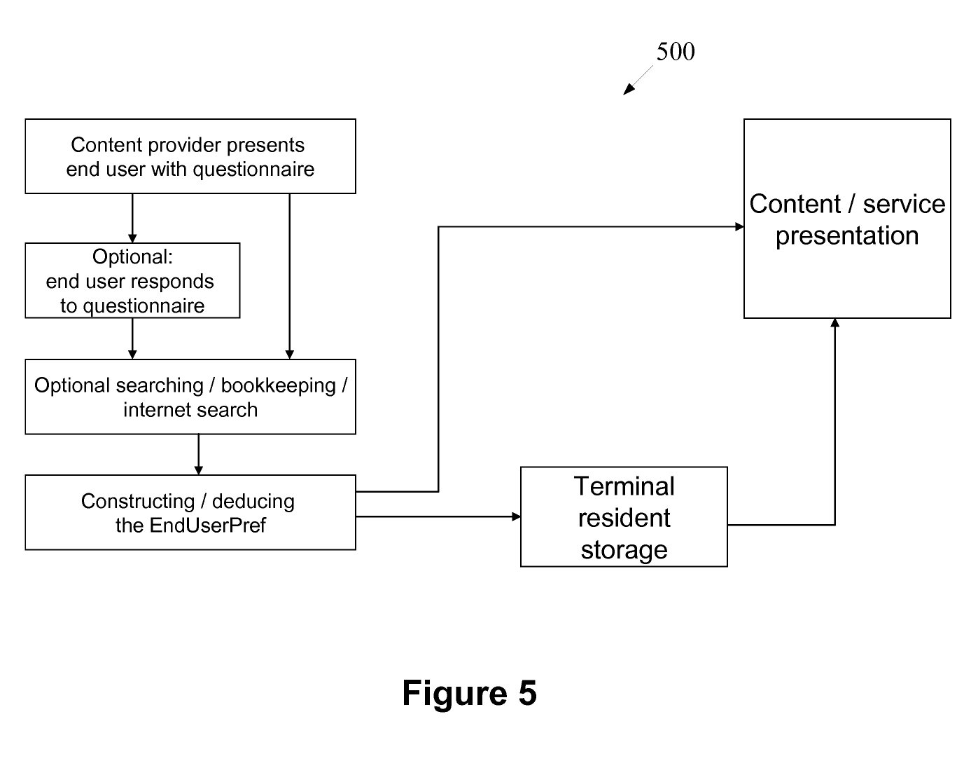

In accordance with different embodiments the data structure to represent end user preferences and profile is referred as EndUserPref. FIG. 5 illustrates an exemplary process 500 for the development of EndUserRef. A content provider presents the end user with a questionnaire that results in EndUserPref. The questionnaire may be presented and the EndUserPref may be formed in numerous ways.

In one embodiment, a user fills in a form on a web page. Answers in the form are given to a script, for example Javascript that constructs the EndUserPref and stores it locally in the terminal.

In another embodiment, upon providing the service or content itself, a similar script is provided with the content or service and executed resulting in the EndUserPref. The resulting EndUserPref can be stored locally in the terminal. Alternatively, the resulting EndUserPref can be stored directly to the XML Document Object Model (DOM) that represents the content or service itself.

In another embodiment, the questionnaire may be an automatic probe or mole that, upon user consent, keeps track of the kind of content the end user prefers, and forms and continuously updates EndUserPref.

In another embodiment, the questionnaire may be an automatic probe or mole that, upon user consent, searches the local files, caches, program settings, bookmarks, etc. and deduces EndUserPref based on this search.

In another embodiment, the questionnaire may be an automatic probe or mole that, upon user consent, searches the Internet resources, for example social networking sites such as Facebook and deduces EndUserPref based on this search.

The local storing of EndUserPref may be achieved by creating dynamically proprietary terminal provisioning management objects (MO) such as for example that are used in OMA Device Management. In this case, there can be any tools or any kind of questionnaire as the MO can, in principle, originate from anywhere.

In one embodiment, the EndUserPref may be applied through a general or standardized format, along with general or standardized characteristics of a particular content/service. The format is known, and, therefore, one can perform comparison between characteristics of the program against the EndUserPref without knowing the semantics of individual parameters or their corresponding values.

In another embodiment, the EndUserPref may be applied through a proprietary format, along with proprietary characteristics of particular content/service. In this regard, content/service specific analysis of the characteristics of particular content/service and the EndUserPref may be required. This embodiment offers the advantage of allowing the most flexible way of characterizing preferences and characteristics.

The EndUserPref may be stored in a variety of locations. In one embodiment, upon launching the consumption of service or content, the EndUserPref can be loaded into the XML DOM object. In another embodiment, upon launching the consumption of service or content, the questionnaire is represented to the end user, and the EndUserPref is constructed specifically for this service or content.

The EndUserPref may be stored in the terminal in a variety of manners. In one embodiment, the EndUserPref may be stored in a proprietary database. In another embodiment, it may be stored in a general or standardized database, such as OMA Device Management. Although stored in a general or standardized database, the EndUserPref may be stored in either a proprietary format or a general or standardized format.

Regardless of the storage method or format of EndUserPref in the storage, the representation of EndUserPref in XML DOM may be either proprietary or standardized.

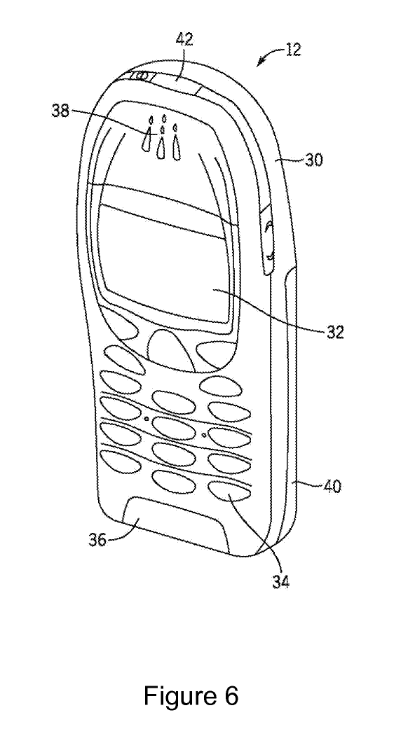

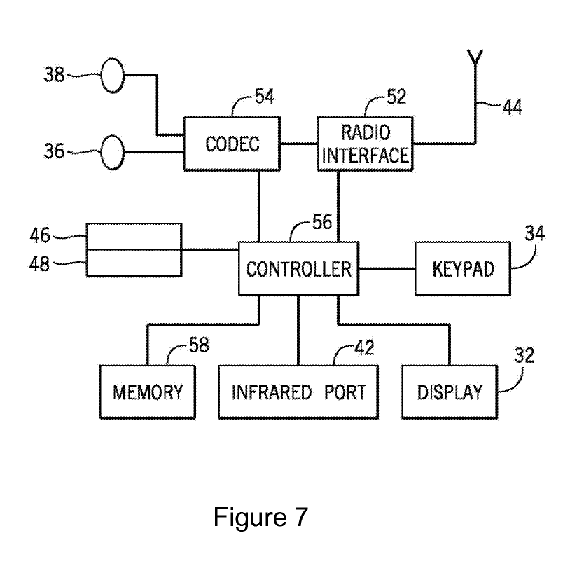

FIGS. 6 and 7 show one representative mobile device 12 within which the embodiments may be implemented. It should be understood, however, that the embodiments are not intended to be limited to one particular type of electronic device. The mobile device 12 of FIGS. 6 and 7 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment, a card reader 48, radio interface circuitry 52, codec circuitry 54, a controller 56 and a memory 58. Individual circuits and elements are all of a type well known in the art, for example in the Nokia range of mobile telephones.

The various embodiments described herein is described in the general context of method steps or processes, which may be implemented in one embodiment by a computer program product, embodied in a computer-readable medium, including computer-executable instructions, such as program code, executed by computers in networked environments. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Software and web implementations of various embodiments can be accomplished with standard programming techniques with rule-based logic and other logic to accomplish various database searching steps or processes, correlation steps or processes, comparison steps or processes and decision steps or processes. It should be noted that the words “component” and “module,” as used herein and in the following claims, is intended to encompass implementations using one or more lines of software code, and/or hardware implementations, and/or equipment for receiving manual inputs.

The foregoing description of embodiments have been presented for purposes of illustration and description. The foregoing description is not intended to be exhaustive or to limit embodiments to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated.

What is claimed is:

1. A method, comprising:
receiving a content update for content presentable using a presentation description language; and
inserting complementary information in the content based on the content update using the presentation description language.

2. A computer program product, embodied in a computer-readable medium, comprising computer code configured to implement the process of claim 1.

3. An apparatus, comprising:
a processor configured to:
receive a content update for content presentable using a presentation description language; and
insert complementary information in the content based on the content update using the presentation description language.

4. An apparatus according to claim 3, wherein said presentation description language comprises at least one of rich media environment and synchronized multimedia integration language.

5. An apparatus according to claim 3, wherein said complementary information comprises one or more of advertisement content, selection information, changes in program schedules, weather notifications and traffic information.

6. An apparatus according to claim 5, wherein said content update comprises a reference to said advertisement content and the processor is further configured to retrieve the advertisement content based on the reference.

7. An apparatus according to claim 5, wherein said content update comprises said advertisement content.

8. An apparatus according to claim 5, wherein the processor is further configured to receive advertisement content from a broadcast delivery session.

9. An apparatus according to claim 3, wherein the content update comprises update commands for updating a scene, said update commands comprise one or more of insertion, deletion, replacement and add operations.

10. An apparatus according to claim 9, wherein the processor is further configured to generate scene updates based at least in part on proprietary signaling from the network.

11. An apparatus according to claim 3, wherein said content update comprises one or more of content update specific to a receiving terminal, end user specific content update and content update to all receiving terminals.

12. A method, comprising:
creating a content update for content presentable using a presentation description language, wherein the content update being associated with complementary information for inserting in the content, the update using the presentation description language; and
transmitting the content update using the presentation description language.

13. A computer program product, embodied in a computer-readable medium, comprising computer code configured to implement the process of claim 12.

14. An apparatus, comprising:
a processor configured to:
create a content update for content presentable using a presentation description language, wherein the content update being associated with complementary information for inserting in the content, the update using the presentation description language; and
computer code for transmitting the content update using the presentation description language.

15. An apparatus according to claim 14, wherein said presentation description language comprises at least one of rich media environment and synchronized multimedia integration language.

16. An apparatus according to claim 14, wherein said complementary information comprises one or more of advertisement content, selection information, changes in program schedules, weather notifications and traffic information.

17. An apparatus according to claim 16, wherein said content update comprises a reference to said advertisement content.

18. An apparatus according to claim 16, wherein said content update comprises said advertisement content.

19. An apparatus according to claim 14, wherein the content update comprises update commands for updating a scene, said update commands comprise one or more of insertion, deletion, replacement and add operations.

20. An apparatus according to claim 14, wherein said content update comprises one or more of content update specific to a receiving terminal, end user specific content update and content update to all receiving terminals.
